(19) United States
(12) Patent Application Publication
(10) Pub. No.: US 2012/0263331 A1
(43) Pub. Date: Oct. 18, 2012

(54) Auditory Animal Abode

(76) Inventors: Michael Newman, Lecanto, FL (US); Kimberly Newman, Lecanto, FL (US)

(21) Appl. No.: 13/447,070

(22) Filed: Apr. 13, 2012

Related U.S. Application Data
(60) Provisional application No. 61/517,066, filed on Apr. 14, 2011.

(51) Int. Cl. H04R 1/02

(52) U.S. Cl. 381/333

(57) ABSTRACT

An auditory animal abode capable of playing the pet owner's voice or other suitable familiar and soothing auditory sound relaxes a pet when the pet owner is not available. An audio device imbeds into a pet's bed. The audio device is positioned so that the pet may easily listen to the recording, but the pet may not have total accessibility to damage the audio device. A pressure plate rests underneath the pet bed. Upon sensing the weight of the pet, the pressure plate activates the audio device. However, the pressure plate may utilize other variables to detect the pet and activate the audio device, such as detecting moisture, movement, sound, or even utilizing camera recognition software to identify a specific pet. Possible recordings may include the pet owner's soothing voice, music, or nature sounds. All of these are efficacious in soothing the pet.

### CROSS-REFERENCE TO RELATED APPLICATIONS

The present Utility patent application claims priority benefit of the U.S. provisional application for patent Ser. No. 61/517,066 filed on Apr. 14, 2011 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to an audio device. More particularly, one or more embodiments of the invention relate to a pet bed including an audio device.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that domesticated animals are typically social animals. Often a familiar voice can be comforting to a domesticated animal. Sometimes when a domesticated animal goes for an extended time without a familiar voice the domesticated animal may feel lonely. Additionally, the domestic animal may participate in destructive behavior when going for an extended time without contact of a familiar voice.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary audio device, in accordance with an embodiment of the present invention; and

FIG. 2 illustrates an exemplary bed, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

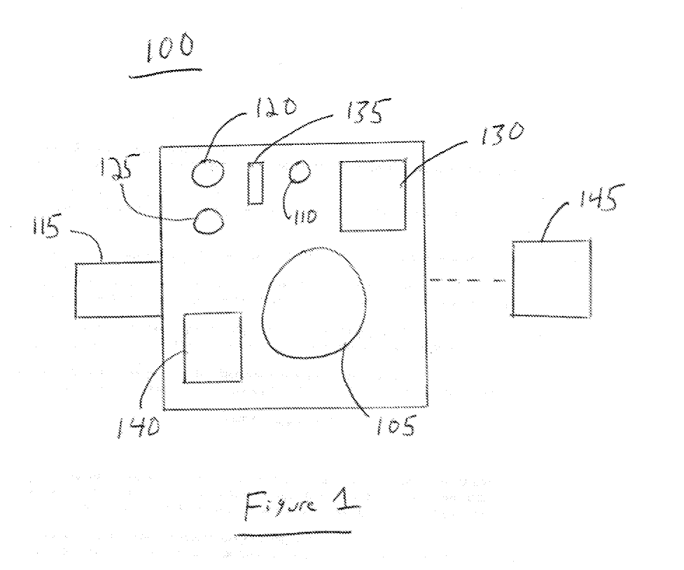

FIG. 1 illustrates an exemplary audio device 100, in accordance with an embodiment of the present invention. The audio device is coupled to a speaker 105. Suitable types of speakers include, but are not limited to, an electrodynamic loudspeaker, a flat panel speaker, a planar magnetic speaker, a diaphragm speaker, a plasma arc speaker, a piezoelectric speaker, and combinations thereof. In some embodiments, the speaker may be coupled to a microphone 110. Suitable types of microphones include, but are not limited to, a dynamic microphone, a ribbon microphone, a condenser microphone, a wireless microphone, a wired microphone, and combinations thereof. In some embodiments, the audio device may be coupled to a storage device 115. In at least one embodiment of the present invention, the storage device 115 may be remotely located from the audio device 100. In some embodiments, the storage device 115 may be removably joined to the audio device 100. Suitable storage devices include, but are not limited to, universal serial bus (USB) drives, volatile memory such as random access memory (RAM), optical media, solid state disks, magnetic media, non-volatile or persistent durable memory, tape drives, jump drives, flash drives, hard-disk drives, compact disk (CD) drives, digital video disk (DVD) drives, Blu-Ray disk drives, and combinations thereof. In some embodiments, the storage device may be configured to store an audio file.

In some embodiments, the audio device 100 may be coupled to a record switch 120. The record switch 120 may be coupled to the storage device 115 in some embodiments. In at least one embodiment of the present invention, the record switch 120 may be coupled to the microphone 110. In some embodiments, the audio device 100 may be coupled to a delete switch 125. In at least one embodiment of the present invention, the delete switch 125 may be configured to delete at least one audio file from the storage device 115. The delete switch 125 may be configured to delete at least a portion of at least one audio file in some embodiments.

In at least one embodiment of the present invention, the audio device 100 may be coupled to a power source 130. Suitable power sources include, but are not limited to, batteries, fuel cells, solar panels, AC power supplies, DC power supplies, generators, alternators, and combinations thereof In some embodiments, the power source 130 may be contained in a casing. In some embodiments, the audio device 100 may be coupled to a regulator switch 135. The regulator switch 135 may be operable to switch the audio device into an “on” position, and an “off” position. In at least one embodiment of the present invention, the regulator switch 135 may also be configured to turn at least one of the speaker 105, the microphone 110, the storage device 115, the record switch 120, and the power source 130 on or off

In some embodiments, the audio device may be coupled to a selection interface 140. In at least one embodiment of the present invention, the selection interface 140 may be configured to select at least one audio file. In some embodiments, the audio file may be located on the storage device 115. The selection interface 140 may be coupled to the delete switch 125 in some embodiments. In at least one embodiment of the present invention, the selection interface 140 may include buttons, for functions including, but not limited to, play, pause, stop, fast forward, rewind, skip, back, up, down, record, delete, volume and tone controls.

In some embodiments, the selection interface 140 may include a touch screen.

In some embodiments, the audio device 100 may be configured to couple with external devices through a connection including, but not limited to, wired connections, cables, wireless connections, WIFI, Bluetooth, local area network (LAN), Infrared (IR) connections, and combinations thereof Suitable external devices include, but are not limited to, a phone, a smartphone, a computer, a tablet computer, a music player, remote control devise and combinations thereof In some embodiments, the audio device 100 may be configured to play an audio file located on the external device.

In at least one embodiment of the present invention, the audio device 100 may be coupled to a pressure plate 145. In some embodiments, the pressure plate 145 may be configured to activate the audio device 100 when the pressure plate 145 senses a weight. However, in alternative embodiments, other variables that may activate the audio device 100 include, but are not limited to: movement on the pressure plate 145, wetness on the pressure plate, thermal energy on the pressure plate, cold on the pressure plate, tearing the pressure plate 145, and excessive weight on the pressure plate 145. Those skilled in the art, in light of the present teachings, can appreciate that the pressure plate 145 may be adjusted to receive different weights before activating the audio device 100. The mass may be a domestic animal in some embodiments. In at least one embodiment of the present invention, the pressure plate may be configured to play at least one audio file when the mass contacts the pressure plate. In some embodiments, the regulator switch 135 may be configured to turn at least one of the wireless port, the selection interface, and the pressure plate on or off

Enabling technologies for some features of the present embodiment include, but are not limited to weight sensitive springs, thermal sensors, laser beam triggers and motion detection devise

In one alternative embodiment, a camera recognizes the pet on the pressure plate 145 with recognition software. In another embodiment, the microphone activates the audio device upon recognition of a unique sound from the pet. If the desired pet is identified, the pressure plate 145 activates the audio device 100.

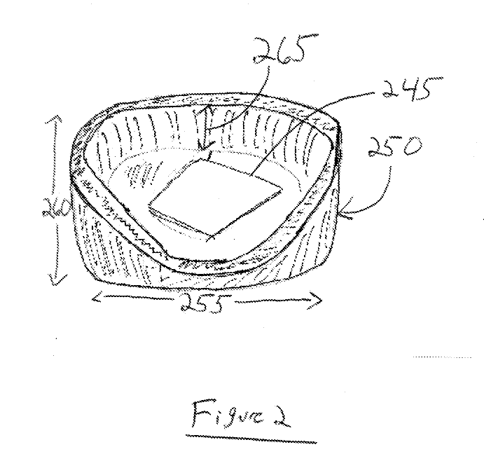

FIG. 2 illustrates an exemplary bed 250, in accordance with an embodiment of the present invention. In some embodiments, the bed 250 may be used by a domestic animal, such as, but not limited to a household pet. Suitable materials for the bed 250 include, but are not limited to, foam, cotton, flannel, satin, down, polyester, wool, acrylic, microfiber, and combinations thereof. In at least one embodiment of the present invention, the bed 250 may include a first dimension 255. A suitable range for the first dimension includes, but is not limited to 8-72 inches. In some embodiments, the bed 250 may include a second dimension 260. A suitable range for the second dimension includes, but is not limited to 8-72 inches. In at least one embodiment of the present invention, the bed 250 may include a third dimension 265. A suitable range for the third dimension includes, but is not limited to.

In some embodiments, the pressure plate 245 may have a surface area. A suitable range for the surface area includes, but is not limited to 4-15 inches. In at least one embodiment of the present invention, the pressure plate 245 may be disposed within at least a portion of the bed 250. In some embodiments, the bed may include an access door. In at least one embodiment of the present invention, the access door may be configured as a flap in the bed 250. The access door may allow a user access to at least one of the pressure plate 245 and the audio device in some embodiments.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing audio device according to the present invention will be apparent to those skilled in the art. The invention has been described above by way of illustration, and the specific embodiments disclosed are not intended to limit the invention to the particular forms disclosed. The particular implementation of the audio device may vary depending upon the particular context or application. By way of example, and not limitation, the audio device described in the foregoing were principally directed to a bed including audio device implementations; however, similar techniques may instead be applied to an audio device with video, including, but not limited to, a video device in a bed, which implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. An audio animal abode comprising:
an audio device, said audio device being operable to provide an audio signal;
at least one speaker, said at least one speaker being operable to emit an audio signal; and
a bed, said bed being configured to receive an animal, said bed comprising a pressure plate, said pressure plate being operable to activate said audio device.

2. The audio animal abode of claim 1, wherein said audio device positions in proximity to said bed.

3. The audio animal abode of claim 2, in which said audio device further comprises a microphone, said microphone being disposed to detect at least one audio signal.

4. The audio animal abode of claim 3, in which said audio device further comprises a record switch, said record switch being operatively joined to said microphone, said record switch being configured to record said at least one audio signal.

5. The audio animal abode of claim 4, in which said audio device further comprises a selection interface, said selection interface being configured to select at least one audio file.

6. The audio animal abode of claim 5, in which said audio device further comprises a storage device, said storage device being configured to store said at least one audio file.

7. The audio animal abode of claim 6, wherein said storage device is remotely located from said audio animal abode.

8. The audio animal abode of claim 7, in which said audio device further comprises a delete switch, said delete switch being configured to delete said at least one audio file.

9. The audio animal abode of claim 8, in which said audio device further comprises a regulator switch, said regulator switch being operable to activate and deactivate said audio device.

10. The audio animal abode of claim 9, wherein said regulator switch is accessible for said animal to activate and deactivate said audio device.

11. The audio animal abode of claim 10, in which said audio device further comprises a power source, said power source being configured to generate power for said audio animal device.

12. The audio animal abode of claim 11, in which said bed further comprises an aperture, said aperture being configured to provide access to said pressure plate.

13. The audio animal abode of claim 12, in which said bed further comprises a foam material.

14. The audio animal abode of claim 13, in which said bed further comprises a first dimension, a second dimension, and a third dimension.

15. The audio animal abode of claim 14, wherein said pressure plate adjusts sensitivity for variable weights of said animals.

16. The audio animal abode of claim 15, wherein said pressure plate activates said audio device upon detecting moisture.

17. The audio animal abode of claim 16, wherein said pressure plate activates said audio device upon detecting motion.

18. The audio animal abode of claim 17, wherein said microphone activates said audio device upon recognizing an animal audio signal.

19. An audio animal abode comprising:
means for mounting an audio device on a bed;
means for entering an audio signal into a microphone of said audio device;
means for storing said audio signal on a storage device of said audio device;
means for actuating a pressure plate on said bed;
means for means for activating said audio device;
means for emitting an audio file; and
means for soothing an animal with said audio file.

20. An audio animal abode comprising:
an audio device, said audio device being operable to provide an audio signal;
at least one speaker, said at least one speaker being operable to emit an audio signal;
a microphone, said microphone being disposed to detect at least one audio signal;
a record switch, said record switch being operatively joined to said microphone, said record switch being operable to record an audio signal;
a selection interface, said selection interface being configured to select at least one audio file;
a storage device, said storage device being configured to store said at least one audio file;
a power source, said power source being configured to generate power for said audio animal device; and
a bed, said bed being configured to receive an animal, said bed comprising a pressure plate, said pressure plate being operable to activate said audio device.
